(19) United States
(12) Patent Application Publication
(10) Pub. No.: US 2023/0381882 A1
(43) Pub. Date: Nov. 30, 2023

(54) TORCH SEAMLESS ACCESSORY ATTACHMENT MECHANISM

(71) Applicant: Linde GmbH, Pullach (DE)

(72) Inventors: Erwan SIEWERT, Pullach (DE); Nakhleh A. HUSSARY, Pullach (DE)

(21) Appl. No.: 18/249,188

(22) PCT Filed: Aug. 9, 2021
(86) PCT No.: PCT/EP2021/025306

§ 371 Date: Apr. 14, 2023

(30) Foreign Application Priority Data
Oct. 21, 2020 (EP) 20020485.7

(51) Int. Cl. B23K 9/32

(52) U.S. Cl. CPC B23K 9/32

(57) ABSTRACT

An accessory holder for a torch, comprising: a body having an inner surface and an outer surface, and at least one accessory arranged on the body of the accessory holder and/or a fastening region arranged on the outer surface of the body of the accessory holder, which fastening region is configured to releasably fasten an accessory to the accessory holder. The body of the accessory holder is releasably connected to the torch, wherein the inner surface of the body of the accessory holder comprises at least one alignment feature that is configured to be mated with a corresponding feature arranged on an outer surface of the torch in a form fitting manner so that the accessory holder resides in a fixed spatial orientation with respect to the torch when the accessory holder is releasably connected to the torch.

The present invention relates to an accessory holder for a torch as well as to a system comprising a torch and an accessory holder connectable to the torch in a releasable fashion.

Regarding torches used for welding, different types of clamping rings are available. Most available types are big, inflexible and need special clamping screws for fixing the respective ring to the torch.

Particularly in arc processing applications, there is a need to attach various accessories to a plasma torch. Such accessories may include alignment tools such as a bubble level, a motion direction indicator, a wire feeder, a gas jet workpiece cleaning nozzle, an anti-spatter jet injection (e.g. a fluid that may be supplied with a hose that terminates in an orifice), an observational camera, etc.

However, all existing solutions require extra clamping mechanisms to reside on the torch and are limited to available space on the torch body.

Often, in case an end user is in need of attaching a fixture on a torch, makeshift solutions are used where fastening rings and spacers are adapted to fit such a fixture to the torch. Usually such rings/spacers are not flexible, and are not easy to put on and take off without disassembling of the torch which is time consuming. Furthermore, such makeshift solutions are often difficult in handling regarding proper alignment of the accessory with respect to the torch. Further problems that often arise are the limitation to the number of accessories that can be attached to a torch due to space limitation on the torch or the size of the tool, a lack of confidence in the results of the accessory due to improper fitting or seating, time spent on searching, identifying and acquiring accessories and fastening means that will work regarding the torch at hand.

Based on the above, the problem to be solved by the present invention is to provide an accessory holder for a torch, particularly for a plasma torch, that is improved regarding the above-stated difficulties.

This problem is solved by an accessory holder having the features of claim 1.

According thereto, the accessory holder comprises:
A body having an inner surface for contacting the torch, and an outer surface, and
at least one accessory arranged (e.g. integrated) on the body of the accessory holder and/or a fastening region arranged on said outer surface of the body of the accessory holder, which fastening region is configured to releasably fasten an accessory to the accessory holder.

According to the invention, the body of the accessory holder is configured to be releasably connected to the torch, wherein the inner surface of the body of the accessory holder comprises at least one alignment feature that is configured to be mated with a corresponding feature provided on an outer surface of the torch in a form fitting manner so that the accessory holder resides in a fixed spatial orientation with respect to the torch when the accessory holder is releasably connected to the torch.

Particularly, the body of the accessory holder can be configured to be fixed to the torch by means of elastic forces provided by the body of the accessory holder. The body can have a C-shape, e.g., can comprise the shape of a ring segment (and thus comprise a discontinuity in its peripheral direction). This allows to slightly deforming the body/ring segment to generate the elastic force to fasten the body of the accessory holder to the torch.

Particularly, the accessory holder can be configured to be releasable connected to the torch by letting the holder encompass the torch and by sliding it downwards or upwards on the torch to achieve the fixed state. Particularly, the accessory holder can be configured to haptically indicate to a user that the fixed state has been reached (e.g. by means of a noticeable resistance to said downward or upward movement).

According to an embodiment of the present invention, the at least one alignment feature is a projection of the inner surface of the body of the accessory holder (or alternatively a recess of the inner surface of the body of the accessory holder).

Particularly, the at least one alignment feature is a projection that is configured to engage with the corresponding feature on said outer surface of the torch in a form fitting manner so that the accessory holder resides in the fixed spatial orientation with respect to the torch when the accessory holder is releasably connected to the torch.

Particularly, in an embodiment, the corresponding feature on said outer surface of the torch is a feature that can have a further function regarding an assembly of the torch.

Particularly, said feature of the torch can be one of the following features: a portion of a nut used to assemble the torch to a torch lead, a portion of an outer surface of a shield cup of the torch (e.g. a portion for grabbing the shield cup and attach it to the torch), a portion of a consumable assembly package or assembly cartridge that is e.g. needed to provide a grip as the cartridge is attached onto the torch.

According to a further embodiment of the present invention, the inner surface of the body of the accessory holder comprises several alignment features each being configured to be mated with a corresponding feature provided on said outer surface of the torch in a form fitting manner, wherein particularly the respective alignment feature is a projection configured to engage with a corresponding feature arranged on said outer surface of the torch in a form fitting manner.

Furthermore, according to an embodiment, the inner surface of the body of the accessory holder comprises several alignment features (wherein particularly each alignment feature can be a projection), wherein each alignment feature is configured to be mated with (particularly to engage with) corresponding features provided on said outer surface of the torch in a form fitting manner so that the accessory holder can reside in different fixed spatial orientations with respect to the torch when the accessory holder is connected to the torch depending on which of the features of the torch the accessory holder's alignment features engage with (or depending on the specific mating between the alignment features and the features of the torch).

According to a further embodiment, the body of the accessory holder is configured to extend along a perimeter of the torch when the accessory holder is connected to the torch (e.g. by way of its ring segment shape, see above), wherein the body of the accessory holder is configured to one of: engage (particularly enclose) the full perimeter of the torch (here the body of the accessory holder can comprise an annular shape), engage at least ¾ of the perimeter of the torch, engage at least ½ of the perimeter of the torch, engage at least ⅓ of the perimeter of the torch.

Further, according to a preferred embodiment, the at least one alignment feature is configured to limit movement of the accessory holder with respect to the torch due to mating of the at least one alignment feature with the corresponding feature of the torch in a radial direction of the torch and/or in a circumferential direction of the torch and/or in an axial direction of the torch.

According to yet another embodiment, the respective alignment feature of the body of the accessory holder (i.e. the at least one alignment feature or each of said several alignment features) comprises one of: an arch shape, a triangular shape, a square shape. Other suitable shapes for achieving a form-fitting connection that limits a movement of the accessory holder with respect to the torch in at least one or in several directions are also conceivable.

Particularly, according to a preferred embodiment, the respective alignment feature can be a projection comprising a top side having one of: an arch shaped edge, a triangular edge, a square edge.

According to a further embodiment of the present invention, the outer surface of the body of the accessory holder comprises a top side and a bottom side, wherein said inner surface of the body of the accessory holder connects said top side to said bottom side, and wherein the body of the accessory holder comprises a top edge formed by the inner surface and the top side of the body of the accessory holder, and wherein the body of the accessory holder comprises a lower edge formed by the inner surface and the bottom side of the body of the accessory holder.

In this regard, the respective alignment feature (i.e. the at least one feature or each of said several features) can terminate at the upper edge of the body of the accessory holder according to an embodiment.

According to a further embodiment, the respective alignment feature (i.e. the at least one feature or each of said several features) terminates at a lower edge of the body of the accessory holder.

However, according to an embodiment, it is also possible that the respective alignment feature (i.e. the at least one alignment feature or each of said several alignment features) is spaced apart from the upper edge. Furthermore, according to an embodiment, the respective alignment feature be can spaced apart from the lower edge of the body of the accessory holder.

Of course, combinations of these embodiments are conceivable, e.g. the respective alignment feature may terminate at the lower edge of the body while being spaced apart from the upper edge of the body (or vice versa).

Particularly, the torch with which the accessory holder can be used is preferably one of: a welding torch, a cutting torch, a spraying torch, a plasma processing torch.

Furthermore, the accessory to be held by the accessory holder or arranged on the accessory holder (particularly integrated into the accessory holder) can be one of the following devices: a level indicator, a wire feed tube, an alignment laser, an anti-spatter injector, a gas cleaning injector, an observational and/or alignment camera, an environmental sensor (e.g. for sensing one of: radiation, sound, temperature, pressure, gas type, distance etc.), a cooling nozzle, a trail (i.e. an elongated shielding gas nozzle for covering a section of a weld seam with a shielding gas), an extended shielding gas nozzle, a vacuum suction member to remove fumes (particulate and/or gaseous).

A further aspect of the present invention relates to a system comprising an accessory holder according to the present invention and a torch, wherein the body of the accessory holder is configured to be releasably connected to the torch, wherein the at least one alignment feature of the accessory holder is configured to be mated with a corresponding feature provided on an outer surface of the torch in a form fitting manner so that the accessory holder resides in a fixed spatial orientation with respect to the torch when the accessory holder is releasably connected to the torch.

Particularly, each alignment feature of said several alignment features of the accessory holder of the system is configured to be mated with (particularly configured to engage with) corresponding features provided on said outer surface of the torch in a form fitting manner so that the accessory holder can reside in different fixed spatial orientations with respect to the torch when the accessory holder is releasably connected to the torch depending on which of the features of the torch the accessory holder's alignment features engage with (or depending on the specific mating between the alignment features and the features of the torch).

Particularly, the respective feature of the torch can be formed on a plasma processing head of the torch (see also the possible features of the torch described above).

Furthermore, the respective feature can have one of: an arch shape, a square shape, a triangular shape. Particularly, the respective feature of the torch can be a recess comprising an edge having one of: an arch shape, a square shape, a triangular shape.

In the following, embodiments, further features and advantages of the present invention shall be explained with reference to the Figures, wherein

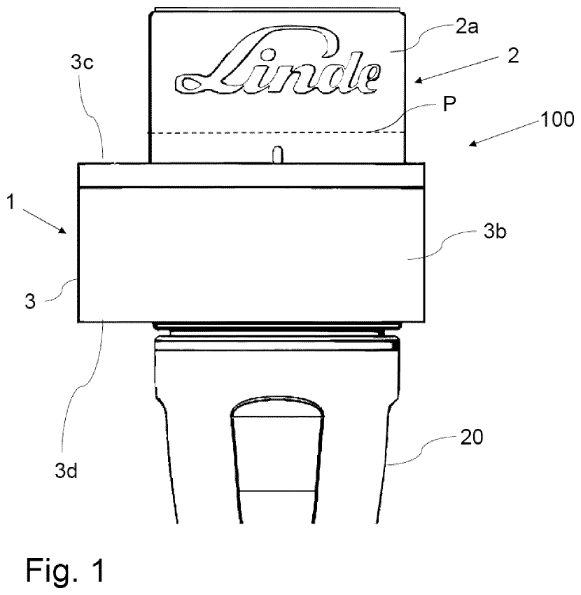

FIG. 1 shows a front view of an embodiment of an accessory holder according to the present invention that is attached to a torch;

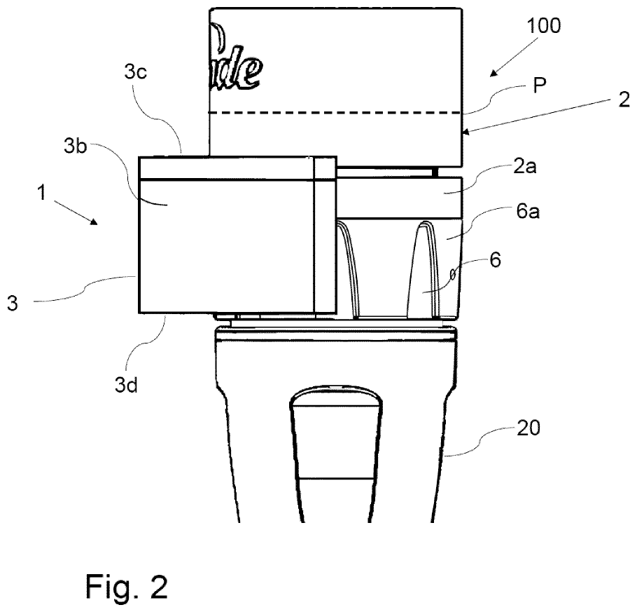

FIG. 2 shows a side view of the accessory holder attached to torch;

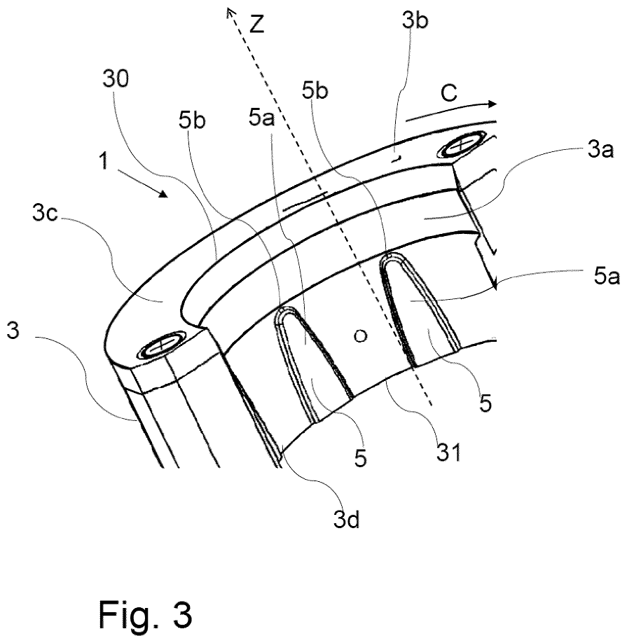

FIG. 3 shows a perspective view of an embodiment of an accessory holder according to the present invention comprising a mating feature on an inner surface; and

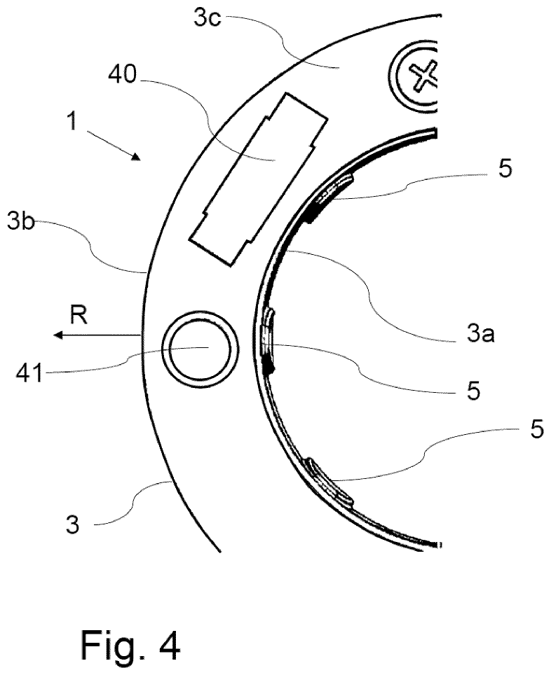

FIG. 4 shows a top view of an embodiment of an accessory holder according to the present invention comprising a bubble level and a laser switch (laser light projects through a bottom side of the accessory holder).

FIG. 1 shows in conjunction with FIGS. 2 to 4 an embodiment of an accessory holder 1 according to the present invention. The accessory holder 1 is configured to be releasably fastened to an outer surface of a torch 2. The torch 2 can be a welding torch or another torch (e.g. as specified herein). The torch 2 can comprise a shield cup 20 (cf. e.g. FIGS. 1 and 2) for discharging a shielding gas, which shield cup forms a part of a processing head of the torch 2.

The accessory holder 1 serves for carrying an integrated accessory 40, 41 and/or as a mount for reliably connecting accessories to the holder 1. For this, the body 3 of the holder 1 can comprise a suitable fastening region provided on the outer surface 3b of the body of the holder 1. As an example, FIG. 4 shows an accessory holder 1 that comprises an accessory 40 in the form of a bubble level 40 integrated into a top side 3c of the body 3 of the accessory holder 1 and a digital display 4 indicating at least one of the following outputs: an angle orientation of the torch, a spatial distance from the torch to the work piece, etc.

Particularly, as indicated in FIGS. 1 and 2, the accessory holder 1 can be configured to be connected to the torch 2 above the shield cup 20, particularly using features 6 of the torch 2 in the form of recesses, which recesses 6 can have an arch shaped edge 6a and are engaged by alignment features in form of projections 5 of the inner surface 3a of the body 3 of the accessory holder 1. However, the shield cup 20 may also be partially covered by the accessory holder 1 in an alternative embodiment.

Engagement of the projections 5 into corresponding recesses 6 of the torch 2 allows giving the accessory holder 1 a defined spatial orientation with respect to the torch 2.

Particularly, the features 6 allow for sliding the body 3 of the holder 1 that is fitted with the corresponding alignment features/projections 5 to perfectly and seamlessly fit the torches outer surface 2a.

The features 6 can be features of the torch 2 that are already present on the torch (i.e. the features/recesses 6 need not to be special-purpose features) and may be used during assembly/handling of the torch 2 (e.g. as grip portions). Such “natural” features 6 on the torch 2 may include features on nuts used to assemble the torch to the torch leads, features on the shield cup's 20 exterior that helps in grabbing the shield cup 20 and attach it on to the torch 2, features on a consumable assembly package or assembly cartridge that is needed to provide a grip as the cartridge is attached onto the torch 2.

Particularly, the geometry on the torch 2, i.e. the features 6, and on the accessory holder 1, i.e. the alignment features 5, allow fixing the accessory holder's body 3 at a particular orientation or multiple orientations as needed, and therewith provides exact localization of the respective accessory 40, 41.

The accessory holder 1 may be of a geometry that fully engages the full perimeter P (circumference) of the torch 2. More preferably, the accessory holder 1 engages a portion of the perimeter (circumference) P of the processing head of the torch 2.

According to preferred embodiment, the body 3 of the accessory holder 1 encloses at least ½ of the perimeter P of the torch 2, wherein the interaction between the alignment features 5 and the features 6 on the torch 2 support fixing of body 3 with respect to at least one of the following directions (preferably with respect to all these directions): a radial direction R of the torch 2, a circumferential direction C of the torch 2, and an axial direction Z of the torch (cf. FIGS. 3 and 4).

Particularly, as shown in FIGS. 3 and 4, the respective projection 5 that protrudes from the inner surface 3a of the body 3 of the holder 1 comprises an arch shape and terminates directly with a straight edge section at a lower edge 31 of the body 3, which lower edge 31 is formed by a bottom side 3d and the inner surface 3a of the body 3 of the holder 1. As further shown in FIG. 3, an arch-shaped edge 5b of a top side 5a of the respective alignment feature/projection 5 is spaced apart from an upper edge 30 of the body 3, which upper edge 30 is formed by a top side 3c of the body 3 and said inner surface 3a of the body 3 of the holder 1.

The present invention offers the advantage, that the individual components of the system 100 can be easily assembled. Particularly, a fast assembly of the respective accessory with respect to the torch 2 is possible in a reliable and reproducible manner. The invention allows a temporary, semi-permanent or permanent attachment of the accessory to the torch 2. Preferably, all consumables are machined or 3D-printed to high accuracy to guarantee alignment in the holder 1 and with respect to each other. Due to the specific fastening mechanism of the present invention, i.e., a clamping/holding force of the ring and a form-fitting engagement between the alignment features of the holder and the corresponding features of the torch, a fast switching of accessories is possible. Furthermore, the accessory holder 1 can provide multiple functionalities in a single holder 1 and guaranties accessory localization in the desired spatial directions.

1. An accessory holder for a torch, comprising:
a body having an inner surface for contacting the torch and an outer surface,
at least one accessory arranged on the body of the accessory holder and/or a fastening region arranged on said outer surface of the body of the accessory holder, which fastening region is configured to releasably fasten an accessory to the accessory holder, characterized in that the body of the accessory holder is configured to be releasably connected to the torch, wherein the inner surface of the body of the accessory holder comprises at least one alignment feature that is configured to be mated with a corresponding feature arranged on an outer surface of the torch in a form fitting manner so that the accessory holder resides in a fixed spatial orientation with respect to the torch when the accessory holder is releasably connected to the torch.

2. The accessory holder according to claim 1, wherein the at least one alignment feature is a projection of the inner surface of the body of the accessory holder or a recess of the inner surface of the body of the accessory holder.

3. The accessory holder according to claim 1, wherein the inner surface of the body of the accessory holder comprises several alignment features, wherein each alignment feature is configured to be mated with corresponding features arranged on said outer surface of the torch in a form fitting manner so that the accessory holder can reside in different fixed spatial orientations with respect to the torch when the accessory holder is connected to the torch depending on which of the features of the torch the accessory holder's alignment features engage with.

4. The accessory holder according to claim 1, wherein the body of the accessory holder is configured to extend along a perimeter of the torch when the accessory holder is connected to the torch, wherein the body of the accessory holder is configured to one of: engage the full perimeter of the torch, engage at least % of the perimeter of the torch, engage at least % of the perimeter of the torch, engage at least ⅓ of the perimeter of the torch.

5. The accessory holder according to claim 1, wherein the respective alignment feature comprises one of:
an arch shape,
a triangular shape,
a square shape.

6. The accessory holder according to claim 1, wherein the outer surface of the body of the accessory holder comprises a top side and a bottom side, wherein said inner surface of the body of the accessory holder connects said top side to said bottom side, and wherein the body of the accessory holder comprises an upper edge formed by the inner surface and the top side of the body of the accessory holder and wherein the body of the accessory holder comprises a lower edge formed by the inner surface and the bottom side of the body of the accessory holder.

7. The accessory holder according to claim 6, wherein the respective alignment feature terminates at the upper edge of the body of the accessory holder, and/or wherein the respective alignment feature terminates at a lower edge of the body of the accessory holder.

8. The accessory holder according to claim 6, wherein the respective alignment feature is spaced apart from the upper edge and/or is spaced apart from the lower edge of the body of the accessory holder.

9. A system comprising an accessory holder according to claim 1 and a torch, wherein the body of the accessory holder is configured to be releasably connected to the torch, wherein the at least one alignment feature of the accessory holder is configured to be mated with a corresponding feature arranged on an outer surface of the torch in a form fitting manner so that the accessory holder resides in a fixed spatial orientation with respect to the torch when the accessory holder is releasably connected to the torch.

10. The system according to claim 9, wherein the torch is one of:
a welding torch,
a cutting torch,
a spraying torch,
a plasma processing torch.

11. The system according to claim 9, wherein the system comprises at least one accessory or several accessories held by the accessory holder or integrated into the accessory holder, wherein the respective accessory is selected from the group comprising:
a level indicator,
a wire feed tube,
an alignment laser,
an anti-spatter injector,
a gas cleaning injector,
an observational and/or alignment camera, an environmental sensor,
a distance sensor,
a trail,
a cooling nozzle.
